(19) United States
(12) Patent Application Publication
(10) Pub. No.: US 2007/0044714 A1
(43) Pub. Date: Mar. 1, 2007

(54) Method and apparatus for maintaining a cross sectional shape of a diffuser during processing

(75) Inventor: John M. White, Hayward, CA (US)

Correspondence Address: PATTERSON & SHERIDAN, LLP, 3040 POST OAK BOULEVARD, SUITE 1500, HOUSTON, TX, 77056, US

(73) Assignee: APPLIED MATERIALS, INC.

(21) Appl. No.: 11/216,968

(22) Filed: Aug. 31, 2005

(51) Int. Cl. B23P 25/00; B23P 11/00

(52) U.S. Cl. 118/715; 29/458; 29/525.01

(57) ABSTRACT

A diffuser for delivering one or more process gasses to a reaction region inside a chamber. The diffuser includes a first plate having a first coefficient of thermal expansion and a second plate coupled to the first plate. The second plate has a second coefficient of thermal expansion that is less than the first coefficient of thermal expansion.

### BACKGROUND OF THE INVENTION

1. Field of the Invention

Embodiments of the present invention generally relate to supplying gasses to a chamber, and more specifically, to a gas distribution plate within the chamber.

2. Description of the Related Art

Flat panel displays employ an active matrix of electronic devices, such as insulators, conductors, and thin film transistors (TFT's) to produce flat screens used in a variety of devices such as television monitors, personal digital assistants (PDA's), and computer screens. Generally, these flat panel displays are made of two thin panels of glass, a polymeric material, or other suitable substrate material. Layers of a liquid crystal material or a matrix of metallic contacts, a semiconductor active layer, and a dielectric layer are deposited through sequential steps and sandwiched between the two thin panels which are coupled together to form a large area substrate having at least one flat panel display located thereon. At least one of the panels will include a conductive film that will be coupled to a power supply which will change the orientation of the crystal material and create a patterned display on the screen face.

These processes typically require the large area substrate to undergo a plurality of sequential processing steps that deposit the active matrix material on the substrate. Chemical vapor deposition (CVD) and plasma enhanced chemical vapor deposition (PECVD) are some of the well known processes for this deposition. These known processes require the large area substrate be subjected to temperatures on the order of 300° C. to 400° C. or higher and be maintained in a fixed position relative to a gas distribution plate, or diffuser, during deposition to ensure uniformity in the deposited layers. The diffuser generally defines an area that is equal to or greater than the area of the substrate. If the shape of the diffuser is not adequately retained during deposition, the process may not produce uniform deposition, which may result in an unusable panel.

Flat panel displays have increased dramatically in size over recent years due to market acceptance of this technology. Previous generation large area substrates had sizes of about 500 mm by about 650 mm and have increased in size to about 1800 mm by about 2200 mm or larger. This increase in size has brought an increase in diffuser size so that the substrate may be processed completely. The larger diffuser size has presented new challenges to design a diffuser that will resist sagging otherwise distorting when exposed to high temperatures during processing.

A diffuser is generally a plate supported in a spaced-apart relation above the large area substrate with a plurality of orifices adapted to disperse process gasses. The diffuser is generally made of aluminum and is subject to thermal expansion during processing. The diffuser is also generally supported around the edges to control spacing between the diffuser and the substrate. It is usually not supported in the center area because the supports would tend to interfere with the flow and distribution of gases behind the diffuser. This edge-only support scheme typically does not provide any support for the center portion. As a result, the diffuser may sag or bow due to forces of gravity, aggravated by high temperatures during processing.

One option to prevent the diffuser from sagging or bowing would be to increase the thickness of the diffuser. However, increasing the thickness of the diffuser would also increase the cost and time of drilling the orifices through the diffuser, which makes the price of the diffuser less attractive.

Therefore, a need exists in the art for a new diffuser with minimal sagging or bowing during processing.

### SUMMARY OF THE INVENTION

Embodiments of the invention are generally directed to a diffuser for delivering one or more process gasses to a reaction region inside a chamber. The diffuser includes a first plate having a first coefficient of thermal expansion and a second plate coupled to the first plate. The second plate has a second coefficient of thermal expansion that is less than the first coefficient of thermal expansion.

Embodiments of the invention are also generally directed to a processing chamber, which includes a diffuser having a first plate having a first coefficient of thermal expansion and a second plate coupled to the first plate. The second plate has a second coefficient of thermal expansion that is less than the first coefficient of thermal expansion. The diffuser further includes a plurality of orifices disposed therethrough. The chamber further includes a substrate support for supporting a substrate, wherein the substrate support is disposed below the diffuser.

Embodiments of the invention are also generally directed a method for manufacturing a diffuser. The method includes providing a first plate having a first coefficient of thermal expansion and a second plate having a second coefficient of thermal expansion that is less than the first coefficient of thermal expansion. The method further includes coupling the first plate with the second plate.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a side view of a chamber having a diffuser in accordance with one or more embodiments of the invention.

FIG. 2 illustrates a diffuser in accordance with one or more embodiments.

FIG. 3 illustrates a partial sectional view of a diffuser in accordance with one or more embodiments of the invention.

### DETAILED DESCRIPTION

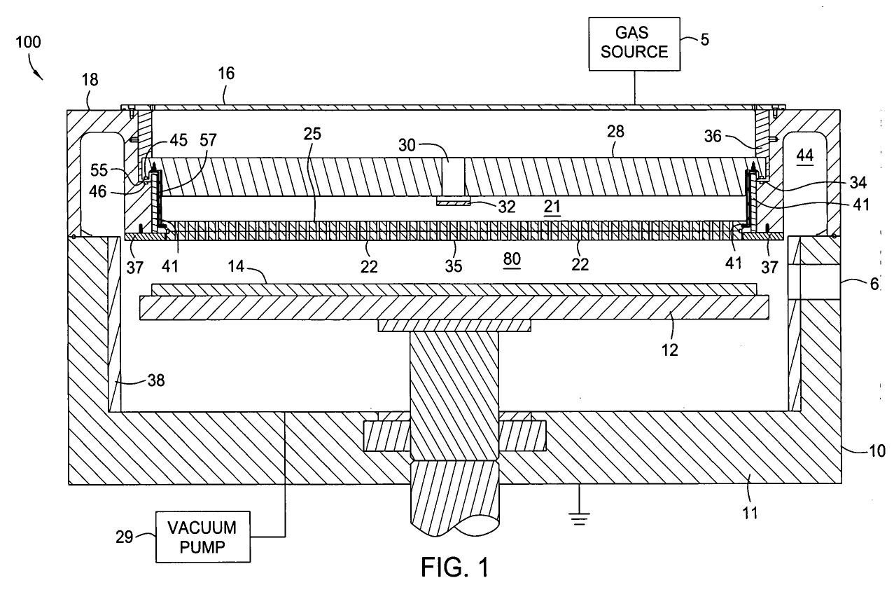

FIG. 1 illustrates a side view of a chamber 100 having a diffuser 20 in accordance with one or more embodiments of the invention. The chamber 100 is suitable for chemical vapor deposition (CVD) or plasma enhanced chemical vapor deposition (PECVD) processes for fabricating the circuitry of a flat panel display on a large area glass, polymer, or other suitable substrate. The chamber 100 may be configured to form structures and devices on a large area substrate for use in the fabrication of liquid crystal displays (LCD's), flat panel displays, photovoltaic cells for solar cell arrays, or organic light emitting diodes (OLED's).

The chamber 100 may be configured to deposit a variety of materials on a large area substrate that includes conductive materials (e.g., ITO, ZnO₂, W, Al, Cu, Ag, Au, Ru or alloys thereof), dielectric materials (e.g., SiO₂, SiOₓN_{y}, HfO₂, HfSiO₄, ZrO₂, ZrSiO₄, TiO₂, Ta₂O₅, Al₂O₃, derivatives thereof or combinations thereof), semiconductive materials (e.g., Si, Ge, SiGe, dopants thereof or derivatives thereof), barrier materials (e.g., SiNₓ, SiOₓN_{y}, Ti, TiNₓ, TiSiₓN_{y}, Ta, TaNₓ, TaSiₓN_{y} or derivatives thereof) and adhesion/seed materials (e.g., Cu, Al, W, Ti, Ta, Ag, Au, Ru, alloys thereof and combinations thereof). Metal-containing compounds that may be deposited by the chamber 100 include metals, metal oxides, metal nitrides, metal silicides, or combinations thereof. For example, metal-containing compounds include tungsten, copper, aluminum, silver, gold, chromium, cadmium, tellurium, molybdenum, indium, tin, zinc, tantalum, titanium, hafnium, ruthenium, alloys thereof, or combinations thereof. Specific examples of conductive metal-containing compounds that may be formed or deposited by the chamber 100 onto the large area substrates may include indium tin oxide, zinc oxide, tungsten, copper, aluminum, silver, derivatives thereof or combinations thereof. The chamber 100 may also be configured to deposit dielectric materials and semiconductive materials in a polycrystalline, amorphous or epitaxial state. For example, dielectric materials and semiconductive materials may include silicon, germanium, carbon, oxides thereof, nitrides thereof, dopants thereof or combinations thereof. Specific examples of dielectric materials and semiconductive materials that may be formed or deposited by the chamber 100 onto the large area substrates include epitaxial silicon, polycrystalline silicon, amorphous silicon, silicon germanium, germanium, silicon dioxide, silicon oxynitride, silicon nitride, dopants thereof (e.g., B, P or As), derivatives thereof or combinations thereof. The chamber 100 may also be configured to receive gases such as argon, hydrogen, nitrogen, helium, or combinations thereof, for use as a purge gas or a carrier gas (e.g., Ar, H₂, N₂, He, derivatives thereof, or combinations thereof). For example, amorphous silicon thin films may be deposited on a large area substrate inside the chamber 100 using silane as the precursor gas in a hydrogen carrier gas.

Examples of various devices and methods of depositing thin films on a large area substrate using the chamber 100 may be found in commonly assigned U.S. patent application Ser. No. 11/173,210, filed Jul. 1, 2005, entitled, “Plasma Uniformity Control By Gas Diffuser Curvature,” which is incorporated herein by reference. Other examples of various devices that may be formed using the chamber 100 may be found in commonly assigned U.S. patent application Ser. No. 10/889,683, filed Jul. 12, 2004, entitled “Plasma Uniformity Control by Gas Diffuser Hole Design,” and in commonly assigned U.S. patent application Ser. No. 10/829,016, filed Apr. 20, 2004, entitled “Controlling the Properties and Uniformity of a Silicon Nitride Film by Controlling the Film Forming Precursors,” which are both incorporated herein by reference.

The chamber 100 may include a chamber sidewall 10, a bottom 11 and a substrate support 12, such as a susceptor, which is configured to support a large area substrate 14. The chamber 100 may further include a port 6, such as a slit valve, that may be configured to facilitate the transfer of the large area substrate 14 by selectively opening and closing. The chamber 100 may also include a lid 18 having an exhaust channel 44 surrounding a gas inlet manifold, which includes a cover plate 16, a backing plate 28 and a gas distribution plate, such as a diffuser 20. The backing plate 28 is sealed on its perimeter by suitable O-rings 45 and 46 at points where the backing plate 28 and the lid 18 join, which protect the interior of chamber 100 from ambient environment and prevent escape of process gasses.

The cross sectional shape of the diffuser 20 may be planar (or flat), convex or concave. The diffuser 20 includes a plurality of orifices 22 for providing a plurality of pathways for one or more process gasses to flow from a gas source 5 coupled to the chamber 100. The diffuser 20 may be configured to be positioned above the substrate 14. The diffuser 20 may also be supported from an upper lip 55 of the lid 18 by a flexible suspension 57. Such flexible suspension is described in more detail in commonly assigned U.S. Pat. No. 6,477,980, which issued Nov. 12, 2002 with the title “Flexibly Suspended Gas Distribution Manifold for A Plasma Chamber” and is incorporated herein by reference. The flexible suspension 57 is configured to support the diffuser 20 from its edges and to allow expansion and contraction of the diffuser 20. The diffuser 20 may be supported by other types of edge suspensions commonly known by persons having ordinary skill in the art. Alternatively, the diffuser 20 may be supported at its perimeter with supports that are not flexible, or at a position inboard of the edge.

The diffuser 20 is in communication with the gas source 5 through a gas conduit 30, which is disposed through the backing plate 28. A gas conduit deflector 32 may be disposed at an end of the gas conduit 30. The gas conduit deflector 32 is configured to block gases from flowing in a straight path from the gas conduit 30 directly to the diffuser 20, thereby facilitating the equalization of gas flow rates through the center and the periphery of the diffuser 20.

The diffuser 20 may be made of or coated with an electrically conductive material so that it may function as an electrode within the chamber 100. The substrate support 12 may also function as an electrode within the chamber 100. The substrate support 12 may further be heated by an integral heater, such as heating coils or a resistive heater coupled to or disposed within the substrate support 12. The materials chosen for the diffuser 20 may include aluminum, steel, titanium, or combinations thereof and the surfaces may be polished or anodized. The diffuser 20 may be electrically insulated from the lid 18 and the wall 10 by dielectric liners 34, 36, 37, 38, and 41.

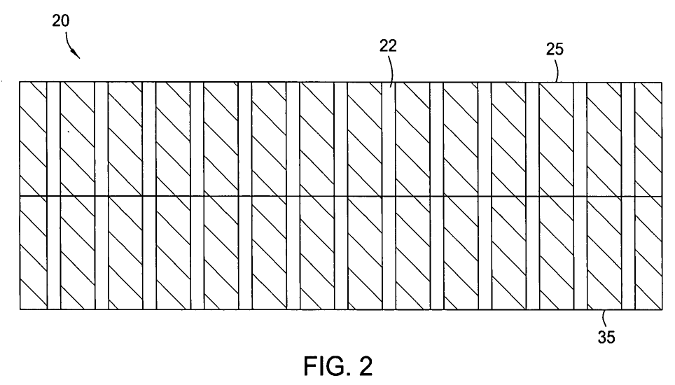

In accordance with one or more embodiments of the invention, the diffuser 20 may be made of two plates joined together, as illustrated in FIG. 2 in greater detail. For example, the diffuser 20 may be made of an upper plate 25 and a lower plate 35. The upper plate 25 may be joined to the lower plate 35 by roll bonding, forging, explosion bonding, fasteners (e.g., screws, rivets, pins and the like), welding, brazing and other various means commonly known by persons having ordinary skill in the art. In one embodiment, the upper plate 25 is joined to the lower plate 35 such that their mating surfaces do not substantially slip and that the two plates transfer heat effectively and predictably.

In one embodiment, the upper plate 25 and the lower plate 35 have different coefficient of thermal expansions. A coefficient of thermal expansion indicates how much a material will expand for each degree of temperature change. For example, the upper plate 25 may have a coefficient of thermal expansion of about 14.4×10⁻⁶ per degree Fahrenheit (F), while the lower plate 35 may have a coefficient of thermal expansion of about 13.4×10⁻⁶ per degree F. In another embodiment, the difference between coefficient of thermal expansions of the upper plate 25 and the lower plate 35 ranges from about 0.5×10⁻⁶ per degree F. to about 2×10⁻⁶ per degree F., e.g., about 1×10⁻⁶ per degree F. Accordingly, the diffuser 20 of embodiments described herein may perform in temperatures ranging from about 200 degrees Celsius to about 400 degrees Celsius, e.g., 250 degrees Celsius. In accordance with the above-referenced embodiments, the cross sectional shape of the diffuser 20 may be maintained during processing at such temperatures.

The diffuser 20 may be oriented in variety of configurations. For instance, the diffuser 20 may be oriented in an off-vertical or vertical plane, as in a so-called vertical reactor. The plate having the lower coefficient of thermal expansion, e.g., the lower plate 35, may be oriented such that it is exposed to the hotter side of the chamber, thereby avoiding excessive distortion due to the thermal gradient through the diffuser 20. As such, the temperature at the plate having the lower coefficient of thermal expansion is higher than the temperature at the other plate. The temperature difference between the two plates may range from about 0° F. to about 50° F., such as about 10° F.

In operation, one or more process gases may be flowed from the gas source 5 while the chamber 100 is pumped down to a suitable pressure by a vacuum pump 29. One or more process gasses travel through the gas conduit 30 and are deposited in a plenum 21 created between backing plate 28 and diffuser 20. The one or more process gasses then travel from the plenum 21 through the plurality of orifices 22 within the diffuser 20 to create a processing region 80 in an area below the diffuser 20. The large area substrate 14 may be raised to this processing region 80 and the plasma excited gas or gases may be deposited thereon to form structures on the large area substrate 14. A plasma may be formed in the processing region 80 by a plasma source (not shown) coupled to the chamber 100. The plasma source may be a direct current power source, a radio frequency (RF) power source, or a remote plasma source. The RF power source may be inductively or capacitively coupled to the chamber 100. A plasma may also be formed in the chamber 100 by other means, such as a thermally induced plasma.

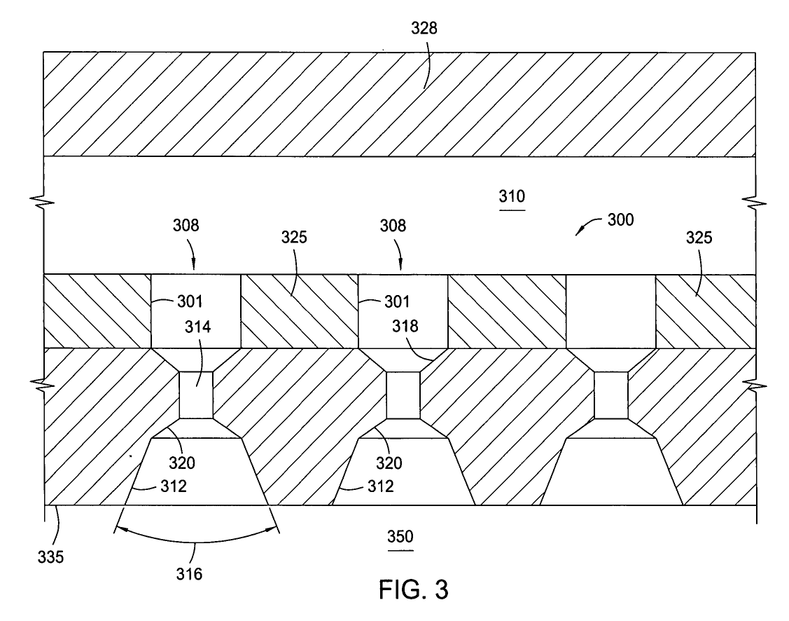

Embodiments of the invention are not limited to diffusers having orifices shown in FIG. 2. For example, embodiments of the invention may be used in diffusers having orifices of different shapes, such as the ones illustrated in FIG. 3. FIG. 3 illustrates a partial sectional view of a diffuser 300, which includes an upper plate 325 and a lower plate 335, each having a different coefficient of thermal expansion. In one embodiment, the difference between coefficient of thermal expansions of the upper plate 325 and the lower plate 335 may range from about 0.5×10⁻⁶ per degree F. to about 2×10⁻⁶ per degree F., e.g., about 1×10⁻⁶ per degree F. A plurality of gas passages 308 are formed through the upper plate 325 and the lower plate 335 to distribute gases from a plenum 310 defined between a backing plate 328 and the diffuser 300 to a processing area 350 below the diffuser 300. The lower plate 335 may be anodized, as anodization on the downstream side has been found to enhance plasma uniformity. The upper plate 325, which is the upstream side, may be optionally free from anodization to limit the absorption of fluorine during cleaning, which may later be released during processing and become a source of contamination.

A first bore 301 is formed through the upper plate 325 and partially in the second plate 335. A second bore 312 and orifice hole 314 are formed in the lower plate 335. Fabrication of the bores and holes 301, 312, 314 separately in each plate 325, 335 allows for more efficient fabrication as drilled length and depth (i.e., position within a plate) of the orifice hole 314 is minimized, further reducing the occurrence of drill bit breakage, thereby reducing fabrication costs.

Each gas passage 308 is defined by the first bore 301 coupled by the orifice hole 314 to the second bore 312 that combine to form a fluid path through the diffuser 300. The first bore 301 includes a bottom 318, which may be tapered, beveled, chamfered or rounded to minimize flow restriction as gases flow from the first bore 301 into the orifice hole 314.

The second bore 312 is formed in the lower plate 335. The diameter of the second bore 312 may be flared at an angle 316 of about 22 to about 35 degrees. The diameter of the first bore 301 may be at least equal to or smaller than the diameter of the second bore 312. A bottom 320 of the second bore 312 may be tapered, beveled, chamfered or rounded to minimize the pressure loss of gases flowing out of the orifice hole 314 and into the second bore 312.

The orifice hole 314 generally couples the bottom 318 of the first bore 301 to the bottom 320 of the second bore 312. The orifice hole 314 may have a diameter of about 0.25 mm to about 0.76 mm (about 0.02 inches to about 0.3 inches) and a length of about 0.040 inches to about 0.085 inches. The diameter and the length (or other geometric attribute) of the orifice hole 314 are the primary source of back pressure in the plenum 310 which promotes even distribution of gas across the upper plate 325. Other details of the diffuser 300 may be found in commonly assigned U.S. patent application Ser. No. 10/417,592, filed Apr. 16, 2003 under the title “Gas Distribution Plate Assembly For Large Area Plasma Enhanced Chemical Vapor Deposition”, which is incorporated herein by reference.

While the foregoing is directed to embodiments of the present invention, other and further embodiments of the invention may be devised without departing from the basic scope thereof, and the scope thereof is determined by the claims that follow.

What is claimed is:

1. A diffuser for delivering one or more process gasses to a reaction region inside a chamber, comprising:
a first plate having a first coefficient of thermal expansion; and
a second plate coupled to the first plate, wherein the second plate has a second coefficient of thermal expansion that is less than the first coefficient of thermal expansion.

2. The diffuser of claim 1, wherein the second plate is disposed below the first plate.

3. The diffuser of claim 1, wherein the cross sectional shape of the diffuser is maintained during processing.

4. The diffuser of claim 1, wherein the first coefficient of thermal expansion is about 14.4×10⁻⁶ per degree Fahrenheit.

5. The diffuser of claim 4, wherein the second coefficient of thermal expansion is about 13.4×10⁻⁶ per degree Fahrenheit.

6. The diffuser of claim 1, wherein the second coefficient of thermal expansion is about 13.4×10⁻⁶ per degree Fahrenheit.

7. The diffuser of claim 1, wherein the difference between the first coefficient of thermal expansion and the second coefficient of thermal expansion is about 1×10⁻⁶ per degree Fahrenheit.

8. The diffuser of claim 1, wherein the difference between the first coefficient of thermal expansion and the second coefficient of thermal expansion is from about 0.5×10⁻⁶ per degree Fahrenheit to about 2×10⁻⁶ per degree Fahrenheit.

9. The diffuser of claim 1, wherein the temperature at the diffuser is about 250 degrees Celsius.

10. The diffuser of claim 1, wherein the temperature difference between the first plate and the second plate is about 10° F.

11. The diffuser of claim 1, wherein the temperature difference between the first plate and the second plate ranges from about 0° F. to about 50° F.

12. The diffuser of claim 1, wherein the diffuser comprises a temperature gradient therethrough and the temperature at the second plate is higher than the temperature at the first plate.

13. The diffuser of claim 1, wherein the temperature at the diffuser is from about 200 degrees Celsius to about 400 degrees Celsius.

14. The diffuser of claim 1, wherein the first plate and the second plate are made of aluminum.

15. A processing chamber, comprising:
a diffuser having:
a first plate having a first coefficient of thermal expansion;
a second plate coupled to the first plate, wherein the second plate has a second coefficient of thermal expansion that is less than the first coefficient of thermal expansion; and
a plurality of orifices disposed therethrough; and
a substrate support for supporting a substrate, wherein the substrate support is disposed below the diffuser.

16. The processing chamber of claim 15, wherein the second plate is disposed below the first plate.

17. The processing chamber of claim 15, wherein the first coefficient of thermal expansion is about 14.4×10⁻⁶ per degree Fahrenheit.

18. The processing chamber of claim 17, wherein the second coefficient of thermal expansion is about 13.4×10⁻⁶ per degree Fahrenheit.

19. The processing chamber of claim 15, wherein the second coefficient of thermal expansion is about 13.4×10⁻⁶ per degree Fahrenheit.

20. The processing chamber of claim 15, wherein the difference between the first coefficient of thermal expansion and the second coefficient of thermal expansion is from about 0.5×10⁻⁶ per degree Fahrenheit to about 2×10⁻⁶ per degree Fahrenheit.

21. The processing chamber of claim 15, wherein the temperature at the diffuser is from about 200 degrees Celsius to about 400 degrees Celsius.

22. A method for manufacturing a diffuser, comprising:
providing a first plate having a first coefficient of thermal expansion and a second plate having a second coefficient of thermal expansion that is less than the first coefficient of thermal expansion; and
coupling the first plate with the second plate.

23. The method of claim 22, wherein the first plate is coupled above the second plate.

24. The method of claim 22, wherein the first plate is coupled to the second plate using at least one of roll bonding, forging, explosion bonding, fasteners, welding and brazing.

25. The method of claim 22, wherein the first coefficient of thermal expansion is about 14.4×10⁻⁶ per degree Fahrenheit and the second coefficient of thermal expansion is about 13.4×10⁻⁶ per degree Fahrenheit.
